(19) United States
(12) Patent Application Publication
(10) Pub. No.: US 2016/0080971 A1
(43) Pub. Date: Mar. 17, 2016

(54) MULTICAST PAGING MESSAGE FOR INDICATING PROPRIETARY PROTOCOL SUPPORT

(71) Applicant: NOKIA SOLUTIONS AND NETWORKS OY, Espoo (FI)

(72) Inventors: John HARRIS, Glenview, IL (US); Tero HENTTONEN, Espoo (FI)

(21) Appl. No.: 14/854,847

(22) Filed: Sep. 15, 2015

Related U.S. Application Data
(63) Continuation-in-part of application No. 14/819,076, filed on Aug. 5, 2015.
Application No. 14/819,076 is a continuation-in-part of application No. PCT/US2015/041073, filed on Jul. 20, 2015.
Application No. PCT/US2015/041073 is a continuation-in-part of application No. PCT/EP2014/069585, filed on Sep. 15, 2014.
(60) Provisional application No. 62/175,676, filed on Jun. 15, 2015.

(51) Int. Cl. H04W 28/02; H04W 68/00; H04L 12/18; H04W 72/00

(52) U.S. Cl. CPC H04W 28/0284; H04W 72/005; H04W 68/00; H04L 12/18

(57) ABSTRACT

Various communication systems may benefit from appropriate indications of protocol support. For example, certain wireless communication systems may use a multicast paging message for indicating proprietary protocol support. A method can include listening, at a user equipment, for a proprietary information message. The proprietary message can be configured to be un-interpreted by non-configured user equipment. The listening can be configured to follow a predefined timing. The method can also include interpreting the proprietary information according to a predetermined configuration when the message is received by the user equipment.

### CROSS REFERENCE TO RELATED APPLICATIONS

This application is a continuation-in-part of U.S. patent application Ser. No. 14/819,076, filed Aug. 5, 2015. This application is also a continuation-in-part of and claims the benefit and priority of PCT/US2015/041073, filed Jul. 20, 2015, the entirety of which is hereby incorporated herein by reference. This application is also a continuation-in-part of and claims the benefit and priority of Patent Cooperation Treaty (PCT) Patent Application No. PCT/EP2014/069585, filed Sep. 15, 2014, which is hereby incorporated herein by reference in its entirety. This application is additionally related to and claims the benefit and priority of U.S. Provisional Patent Application No. 62/175,676 filed Jun. 15, 2015, which is hereby incorporated herein by reference in its entirety.

### BACKGROUND

1. Field

Various communication systems may benefit from appropriate indications of protocol support. For example, certain wireless communication systems may use a multicast paging message for indicating proprietary protocol support.

2. Description of the Related Art

System information in the long term evolution (LTE) of third generation partnership project (3GPP) can rely on periodic transmissions. For example, master information block (MIB) and system information block one (SIB1) can be sent with fixed timing, whereas the other system information blocks (SIBs) can be sent according to information supplied by SIB1. MIB can be sent every 40 ms at subframe #0, with repetitions occurring every 10 ms. SIB1 can be sent every 80 ms at subframe #5, with repetitions occurring every 20 ms.

Paging in LTE can rely on UEs listening to paging occasions according to predefined time instants defined in 3GPP technical specification (TS) 36.304, according to the parameters broadcast by the serving cell in system information block two (SIB2). 3GPP TS 36.304 is hereby incorporated herein by reference in its entirety.

In modern operating systems, devices such as phones may wait for a certain time to send non-time-critical information to the network. In such occasions, if the user equipment (UEs) may wait for some time to obtain better channel conditions, in order to have better power saving due to data transmissions being transmitted and received faster.

### SUMMARY

According to certain embodiments, a method can include listening, at a user equipment, for a proprietary information message. The proprietary message can be configured to be un-interpreted by non-configured user equipment. The listening can be configured to follow a predefined timing. The method can also include interpreting the proprietary information according to a predetermined configuration when the message is received by the user equipment.

In certain embodiments, a method can include preparing a proprietary information message. The proprietary message can be configured to be un-interpreted by non-configured user equipment. The method can also include transmitting the proprietary information to a user equipment according to a predefined timing. The user equipment can be configured to interpret the proprietary information according to a predetermined configuration when the message is received by the user equipment.

According to certain embodiments, an apparatus can include at least one processor and at least one memory including computer program instructions. The at least one memory and the computer program instructions can be configured, with the at least one processor, cause the apparatus at least to listen, at a user equipment, for a proprietary information message. The proprietary message can be configured to be un-interpreted by non-configured user equipment. The listening can be configured to follow a predefined timing The at least one memory and the computer program instructions can also be configured, with the at least one processor, to cause the apparatus at least to interpreting the proprietary information according to a predetermined configuration when the message is received by the user equipment.

In certain embodiments, an apparatus can include at least one processor and at least one memory including computer program instructions. The at least one memory and the computer program instructions can be configured, with the at least one processor, cause the apparatus at least to prepare a proprietary information message. The proprietary message can be configured to be un-interpreted by non-configured user equipment. The at least one memory and the computer program instructions can also be configured, with the at least one processor, to cause the apparatus at least to transmit the proprietary information to a user equipment according to a predefined timing The user equipment can be configured to interpret the proprietary information according to a predetermined configuration when the message is received by the user equipment.

According to certain embodiments, an apparatus can include means for listening, at a user equipment, for a proprietary information message. The proprietary message can be configured to be un-interpreted by non-configured user equipment. The listening can be configured to follow a predefined timing The apparatus can also include means for interpreting the proprietary information according to a predetermined configuration when the message is received by the user equipment.

In certain embodiments, an apparatus can include means for preparing a proprietary information message. The proprietary message can be configured to be un-interpreted by non-configured user equipment. The apparatus can also include means for transmitting the proprietary information to a user equipment according to a predefined timing. The user equipment can be configured to interpret the proprietary information according to a predetermined configuration when the message is received by the user equipment.

A computer program product can include instructions for performing any of the above-described methods.

A non-transitory computer-readable medium can be encoded with instructions that, when executed in hardware, perform any of the above-described methods.

### BRIEF DESCRIPTION OF THE DRAWINGS:

For proper understanding of the invention, reference should be made to the accompanying drawings, wherein:

FIG. 1 illustrates multicast network knowledge messages according to certain embodiments.

FIG. 2 illustrates further network knowledge messages according to certain embodiments.

FIG. 3 illustrates additional network knowledge messages according to certain embodiments.

FIG. 4 illustrates network knowledge messages with a fixed offset to system information block messages according to certain embodiments.

FIG. 5 illustrates network knowledge messages with a fixed offset to a system information block modification period according to certain embodiments.

FIG. 6 illustrates a method according to certain embodiments.

FIG. 7 illustrates a system according to certain embodiments.

### DETAILED DESCRIPTION

Proprietary network assistance, such as congestion data, can be provided through the one or more values that are reserved according to predefined rules, such as international mobile subscriber identities (IMSI) values, within paging messages in order to convey specific network assistance data to UEs. One such reserved IMSI may indicate that that particular cell is particularly congested. Another such IMSI may indicate that that particular cell is relatively un-congested. Both of these IMSIs may convey that the network supports a specific proprietary protocol. This mechanism may be used alone or in combination with the other described embodiments. The cn-Domain can be indicated with the reserved IMSI value within the Page Message. In this way, with a single reserved IMSI value, one bit of network assistance data can be conveyed by controlling the determination as to whether the cn-Domain is set to be PS or CS, e.g. where PS indicates that the network is relatively congested, and CS indicates that it is relatively uncongested.

In addition, a dummy system information block (SIB) can be used to convey network knowledge to the UE. This dummy SIB can be consistently scheduled during a frame and subframe where a particularly substantial portion of the UEs are already waking up and monitoring the downlink, for example with their modem already on. For example such an occasion could coincide with a subframe where SIB1 is sent or N subframes before or after SIB1 is sent. Thus, the timing of the information could coincide with wake-up times of the UE. By utilizing this technique, a large fraction of the UEs, for example all or a substantial portion of the connected UEs and/or all or a substantial portion of the idle UEs, to frequently and periodically check the dummy SIB for updated network knowledge information, such as network congestion information.

The network assistance data may be conveyed through additional dummy system information block(s), such as system information block 34. This can be done by adding additional values to the SIB-TYPE list within SIB1 so that the dummy SIB(s) are using large enough values that may take a long time to get utilized in LTE standard. This can further avoid conflict with the LTE standard even as additional SIB types are added, while avoiding the need to add yet additional bit to SIB-TYPE, which may be required if the SIB number were incremented beyond 34, where 34 corresponds to 32 values beyond SIB1.

Paging frames may not be configured such that they occur frequently, e.g. every 320 ms. In order to avoid the need for a proprietary protocol indication over unicast the proprietary protocol indication may need to be delivered over the air interface more frequently, for example every 320 ms. The periodicity for the occurrences of the indications may be implicitly known by the UEs, or configured via other means such as indication from UE higher layers.

A user equipment (UE) may not be aware of the network conditions other than for the radio conditions the UE itself sees. The network may be able to predict the traffic patterns occurring based, for example, on a time of the day such as busy hour, expected load coming from a class of devices such as machine-type-communication (MTC) devices, an amount of currently active UEs, evolved node B (eNB) internal processing load, experienced interference in uplink, or the like. However, a UE transitioning from RRC_IDLE to RRC_CONNECTED may have no conventional way of knowing these conditions. Thus, a UE may make an attempt to start RRC connection but suffer from poor throughput due to e.g. afore-mentioned aspects.

If the network were able to inform UEs of access-related parameters such as eNB load information, the UEs might be able to re-schedule their data occasions based on the information to obtain the best possible throughput.

Since UEs in RRC_IDLE may be listening to the channel at different times, a mechanism to indicate the information can be synchronized between the UEs. Otherwise some UEs might randomly miss the information, or even never receive that prior to attempting the access, which may lead to poor battery lifetime and user experience.

Some systems address cases where there is an actual UE that actually needs to be paged, and knowledge of the network congestion can be used to determine to page that UE first only where it is un-congested. In contrast, certain embodiments address a situation in which no particular UE is being paged. Additionally, in certain embodiments the IMSI is included at the eNB only where it is congested, or the like.

According to certain embodiments, a UE can follow a predefined timing to listen to proprietary information. The proprietary information can be a message that legacy UEs will not attempt to interpret. This message can be multicast to one or more UEs at the same, or almost the same, time those UEs would already be listening to the channel. For example, the message may be sent at the same time as SIB1 reception is done and/or outside the normal paging cycle determined according to an IMSI. Receiving the message contents at the pre-defined timing instant may allow the UE to recognize that the message is intended to be interpreted as proprietary information that can be utilized to obtain more information about the access network conditions. The network conditions can include network loading conditions.

For example, the timing might follow SIB1 transmission and the message could be identified as a paging message sent to a specific IMSI, but outside the paging occasion determined by the IMSI and cell parameters. From the message addressee, for example IMSI or S-TMSI, the UE could then interpret the communicated information, such as network loading conditions.

In certain embodiments, a user equipment configured to support the procedure can implicitly or explicitly determine the time occasion when the UE should attempt to listen to the multicast message.

In certain embodiments, the timing occasions can be determined according to one or more implicit or explicit IMSI values and the rules specified in TS36.304 for paging frame and paging occasion for those one or more IMSI values. In further embodiments, the time occasion can be fixed in relation to the system frame number (SFN) according to a set periodicity. Similarly, there may be additional fixed occasions related to the other fixed timing occasions.

In other embodiments, the timing occasions can be determined according to a single fixed relation with a set repetition period. For example, the occasion can be assumed to be, for example, subframe #5 in frames when SFN mod 320=1 and every 20 ms after that for 8 times.

The message the UE listens to, in certain embodiments, can be denoted as a multicast message. The contents of the multicast message can be identical to an existing paging message. However, the interpretation of the message may vary from the normal paging message.

In certain embodiments, the multicast message can be identified by P-RNTI. In other embodiments, the multicast message can be identified by an implicitly or explicitly defined C-RNTI. In another embodiment, the multicast message can be addressed via a combination of P-RNTI and C-RNTI. The P-RNTI (and/or the message conveyed with the P-RNTI) can indicate the UE should listen to a specific C-RNTI according to the pre-determined timing. For example, in one embodiment the P-RNTI may point at a paging message, and that paging message may contain a reserved IMSI value, wherein the reserved IMSI value indicates that the UE should listen to a specific C-RNTI according to the pre-determined timing for the multicast message. Furthermore this reserved IMSI value may indicate the periodicity with which the multicast message is repeated and/or delivered.

At least one occasion of the multicast message can be tied to the timing of the SIB1 message. In certain embodiments, the multicast message can be sent in the same subframe as an SIB1 message. In other embodiments, the multicast message can be sent N subframes following the SIB1 message, where N is determined implicitly or explicitly.

In certain embodiments, the multicast message can be sent at the next possible subframe following the SIB1 message. Moreover, in certain embodiments the multicast message can be sent in the first DL subframe following the SIB1 message. For example, in case of TDD configuration #1, the next full DL subframe can occur at subframe #9.

The interpretation of at least one of the reserved IMSI and the multicast message may be scrambled using information known by both the UE and the eNB such as the cell ID and/or PLMN. In certain embodiments, the network can perform this message scrambling/encryption. Upon activation of the service, the UE can be provided with the information on how to descramble/deencrypt this information in specific contexts, such as within a particular PLMN in one or more cell IDs. In further embodiments, if the UE has not been provisioned with the information on how to descramble this information, then the UE may not make use of the information received over the reserved IMSI and/or multicast message. In certain further embodiments, the information on how to descramble this information can be provided via at least one of: over a UE operating system (OS) update, and/or in response to a universal resource locator (URL) query, e.g. a hyper-text transfer protocol (HTTP) or web query.

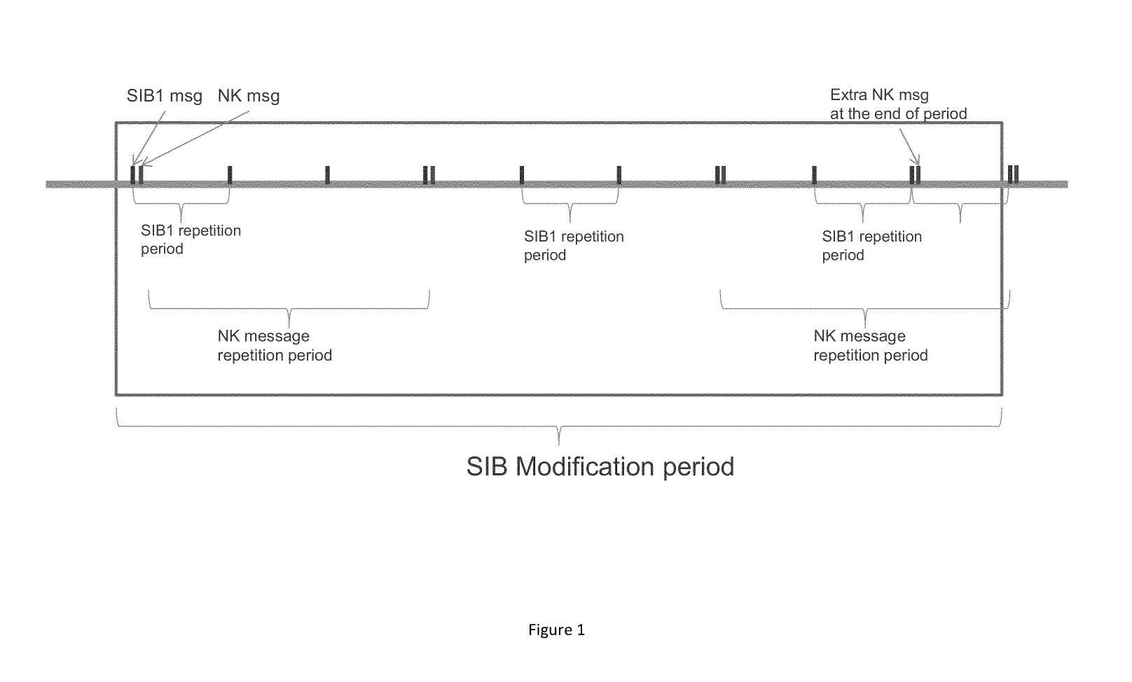

FIG. 1 illustrates multicast network knowledge messages according to certain embodiments. As shown in FIG. 1, within a system information block (SIB) modification period, there can be SIB 1 messages (SIB1 msg) and network knowledge messages (NK msg). The SIB1 messages can follow a SIB1 repetition period, while the network knowledge messages can follow a NK message repetition that can be longer. Optionally, extra knowledge messages can be provided within the repetition period, such as an extra NK msg at the end of an SIB1 repetition period.

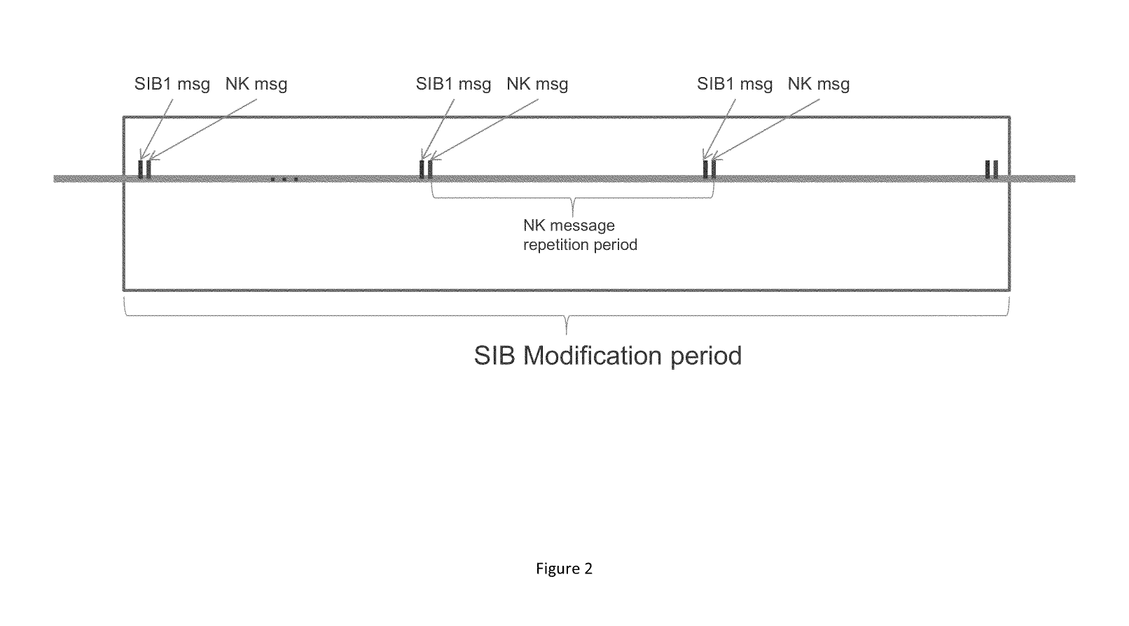

FIG. 2 illustrates further network knowledge messages according to certain embodiments. As shown in FIG. 2, in certain embodiments the knowledge messages can be simply repeated after the SIB1 message. Thus, for example, the NK message repetition period can be the same as but slightly offset from the SIB1 message repetition period.

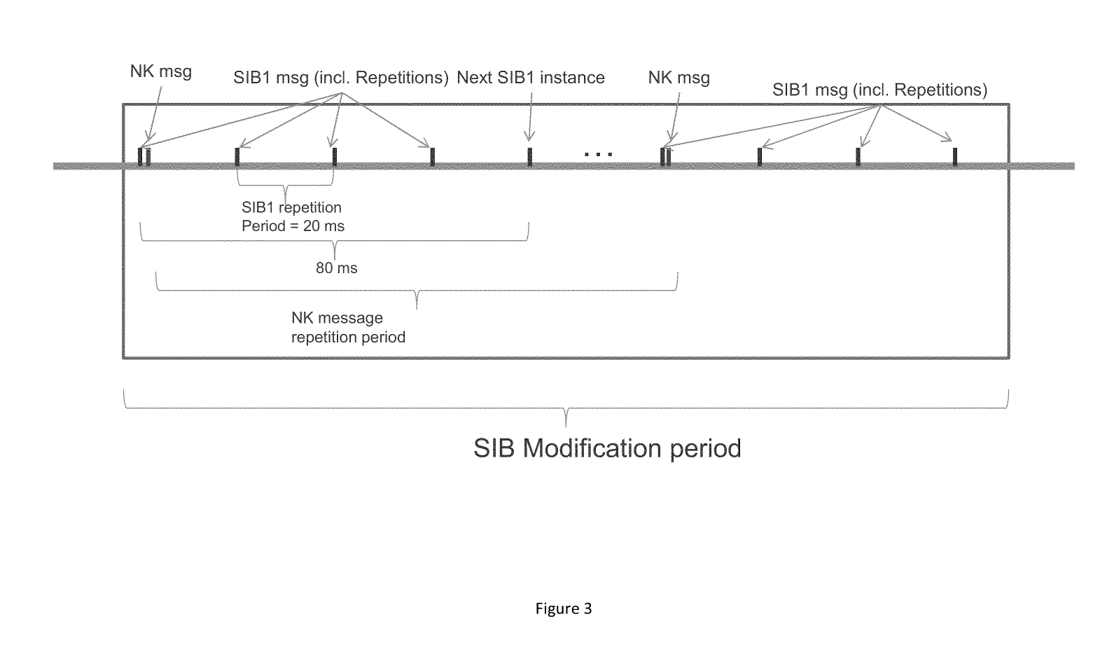

FIG. 3 illustrates additional network knowledge messages according to certain embodiments. As shown in FIG. 3, in certain embodiments, the NK message repetition period can be configured to be much longer than the SIB1 repetition period. Thus, the NK message repetition period may be arranged such that the repetition of the NK message comes even after a next SIB1 instance has been presented.

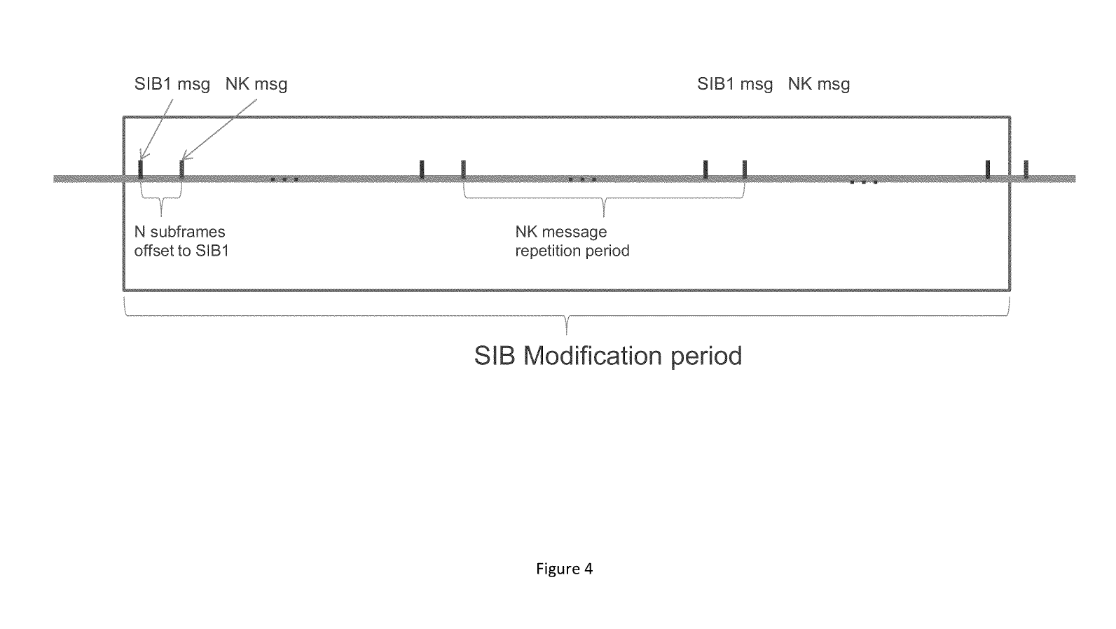

FIG. 4 illustrates network knowledge messages with a fixed offset to system information block messages according to certain embodiments. As shown in FIG. 4, the network knowledge messages can be arranged to follow the SIB1 message by a fixed offset of N frames. In this case, N could be as small as one, such that the NK msg is in the next frame, or can be a greater number of frames.

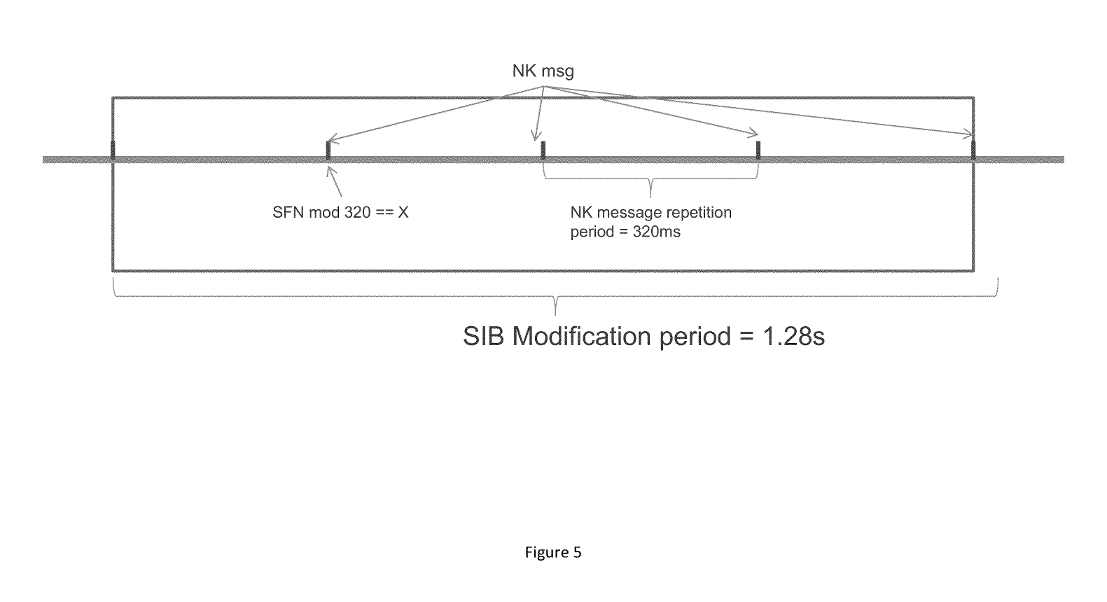

FIG. 5 illustrates network knowledge messages with a fixed offset to a system information block modification period according to certain embodiments. As shown in FIG. 5, the network knowledge messages can be sent at fixed intervals, such as every 320 ms within an SIB modification period of 1.28s. Other intervals are also permitted.

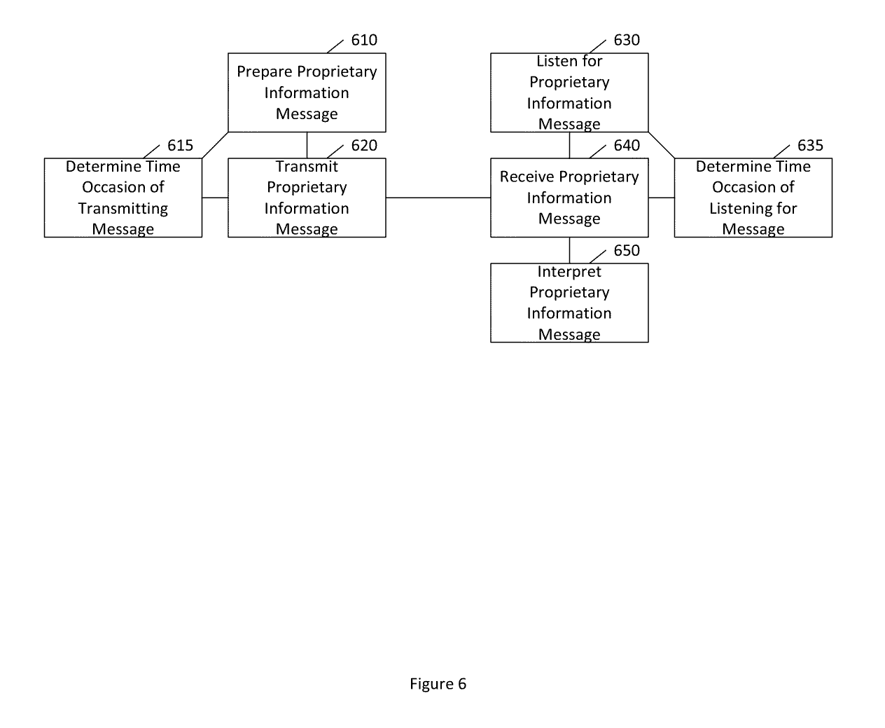

FIG. 6 illustrates a method according to certain embodiments. As shown in FIG. 6, a method can include, at 610, preparing a proprietary information message. The proprietary message can be configured to be un-interpreted by non-configured user equipment. For example, the message can be configured such that a non-configured user equipment will not even attempt to interpret it when operating to any standard. Alternatively, message can be configured such that if a non-configured user equipment attempts to interpret it, then interpretation will not result in any new messaging, when operating to any standard.

The preparing, at 610, can be based on observing or otherwise obtaining network knowledge, such as knowledge of network conditions including, for example, network congestion or network load conditions. Other network knowledge can also be gathered in, or prior to, the preparing.

The method can also include, at 620, transmitting the proprietary information to a user equipment according to a predefined timing, wherein the user equipment is configured to interpret the proprietary information according to a predetermined configuration when the message is received by the user equipment. The proprietary message can be a network knowledge message and can be transmitted according to any of the ways of illustrated in FIGS. 1 through 5.

The method can further include, at 615, determining, implicitly or explicitly, a time occasion when the message should be transmitted to the user equipment. A variety of possible time occasions are illustrated in FIGS. 1 through 5, which are discussed above.

The method can also include, at 630, listening, at a user equipment, for a proprietary information message. The proprietary message can, as mentioned above, be configured to be un-interpreted by non-configured user equipment. The listening can be configured to follow a predefined timing This can be the same predefined timing used to transmit the message at 620.

The method can further include, at 650, interpreting the proprietary information according to a predetermined configuration when the message is received by the user equipment at 640.

The message can be multicast to a plurality of user equipment listening on a channel. The message can be received at the user equipment at a same time as system information block reception, such as system information block one (SIB1). Here, the same time can refer broadly to within a SIB modification period or more narrowly to within a frame or a few frames of the SIB1. The message can be received outside a normal paging cycle.

The interpreting at 650 can include interpreting the proprietary information to obtain information about at least one network condition of an access network. The at least one condition can include a loading condition, such as whether there is network congestion. Other network conditions are also mentioned above.

The message can be identified as being sent to a specific international mobile subscriber identity but can be sent and received outside a paging occasion determined by the international mobile subscriber identity.

The interpreting can include interpreting the proprietary information from the international mobile subscriber identity.

The method can further include, at 635, determining, implicitly or explicitly, a time occasion when the user equipment should attempt to listen to the message. The time occasion can be determined according to one or more implicit or explicit international mobile subscriber identity values. The time occasion can be fixed in relation to a system frame number according to a set periodicity. Alternatively, the time occasion can be determined according to a single fixed relation with a set repetition period. The time occasion can be tied to the timing of a system information block message such as system information block one, which has a fixed timing.

The message can be identified by at least one of paging radio network temporary identifier, an implicitly or explicitly defined cell radio network temporary identifier, or a combination of at least one of paging radio network temporary identifier and an implicitly or explicitly defined cell radio network temporary identifier.

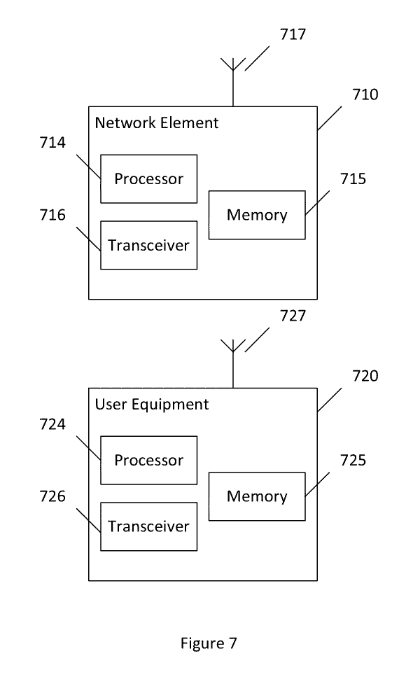

FIG. 7 illustrates a system according to certain embodiments of the invention. It should be understood that each block of the flowchart of FIG. 6 may be implemented by various means or their combinations, such as hardware, software, firmware, one or more processors and/or circuitry. In one embodiment, a system may include several devices, such as, for example, network element 710 and user equipment (UE) or user device 720. For example, features 610, 615, and 620 can be performed by network element 710, while features 630, 635, 640, and 650 can be performed by user equipment 720.

The system may include more than one UE 720 and more than one network element 710, although only one of each is shown for the purposes of illustration. A network element can be an access point, a base station, an eNode B (eNB), or any other network element. Each of these devices may include at least one processor or control unit or module, respectively indicated as 714 and 724. At least one memory may be provided in each device, and indicated as 715 and 725, respectively. The memory may include computer program instructions or computer code contained therein, for example for carrying out the embodiments described above.

One or more transceiver 716 and 726 may be provided, and each device may also include an antenna, respectively illustrated as 717 and 727. Although only one antenna each is shown, many antennas and multiple antenna elements may be provided to each of the devices. Other configurations of these devices, for example, may be provided. For example, network element 710 and UE 720 may be additionally configured for wired communication, in addition to wireless communication, and in such a case antennas 717 and 727 may illustrate any form of communication hardware, without being limited to merely an antenna.

Transceivers 716 and 726 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example.

A user device or user equipment 720 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. The user device or user equipment 720 may be a sensor or smart meter, or other device that may usually be configured for a single location.

In an exemplifying embodiment, an apparatus, such as a node or user device, may include means for carrying out embodiments described above in relation to FIG. 6.

Processors 714 and 724 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof.

For firmware or software, the implementation may include modules or unit of at least one chip set (e.g., procedures, functions, and so on). Memories 715 and 725 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 710 and/or UE 720, to perform any of the processes described above (see, for example, FIG. 6). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 7 illustrates a system including a network element 710 and a UE 720, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

While the discussion uses IMSI as an example, other identifiers such as system architecture evolution (SAE) temporary mobile subscriber identity (S-TMSI) can be conveyed to UEs using a suitable mechanism. Any such identifier may be used in certain embodiments. UEs configured according to certain embodiments may know what to listen for and other UEs can simply ignore these identifiers. The interpretation of the values of the identifiers can be known a priori by the UE.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

We claim:

1. A method, comprising:
listening, at a user equipment, for a proprietary information message, wherein the proprietary message is configured to be un-interpreted by non-configured user equipment, wherein the listening is configured to follow a predefined timing; and
interpreting the proprietary information according to a predetermined configuration when the message is received by the user equipment.

2. The method of claim 1, wherein the message is multicast to a plurality of user equipment listening on a channel.

3. The method of claim 1, wherein the message is received at the user equipment at a same time as system information block reception.

4. The method of claim 1, wherein the message is received outside a normal paging cycle.

5. The method of claim 1, wherein the interpreting comprises interpreting the proprietary information to obtain information about at least one network condition of an access network.

6. The method of claim 5, wherein the at least one condition comprises a loading condition.

7. The method of claim 1, wherein the message is identified as being sent to a specific international mobile subscriber identity but is received outside a paging occasion determined by the international mobile subscriber identity.

8. The method of claim 7, wherein the interpreting comprises interpreting the proprietary information from the international mobile subscriber identity.

9. The method of claim 1, further comprising:
determining, implicitly or explicitly, a time occasion when the user equipment should attempt to listen to the message.

10. The method of claim 9, wherein the time occasion is determined according to one or more implicit or explicit international mobile subscriber identity values.

11. The method of claim 9, wherein the time occasion is fixed in relation to a system frame number according to a set periodicity.

12. The method of claim 9, wherein the time occasion is determined according to a single fixed relation with a set repetition period.

13. The method of claim 9, wherein the time occasion is tied to the timing of a system information block message.

14. The method of claim 1, wherein the message is identified by at least one of paging radio network temporary identifier, an implicitly or explicitly defined cell radio network temporary identifier, or a combination of at least one of paging radio network temporary identifier and an implicitly or explicitly defined cell radio network temporary identifier.

15. A method, comprising:
preparing a proprietary information message, wherein the proprietary message is configured to be un-interpreted by non-configured user equipment,
transmitting the proprietary information to a user equipment according to a predefined timing, wherein the user equipment is configured to interpret the proprietary information according to a predetermined configuration when the message is received by the user equipment.

16. The method of claim 15, wherein the message is multicast to a plurality of user equipment listening on a channel.

17. The method of claim 15, wherein the message is transmitted to the user equipment at a same time as system information block transmission.

18. The method of claim 15, wherein the message is transmitted outside a normal paging cycle.

19. The method of claim 15, wherein the proprietary information is configured to convey information about at least one network condition of an access network.

20. The method of claim 19, wherein the at least one condition comprises a loading condition.

21. The method of claim 15, wherein the message is identified as being sent to a specific international mobile subscriber identity but is transmitted outside a paging occasion determined by the international mobile subscriber identity.

22. The method of claim 21, wherein the proprietary information is conveyed in the international mobile subscriber identity.

23. The method of claim 15, further comprising:
determining, implicitly or explicitly, a time occasion when the message should be transmitted to the user equipment.

24. The method of claim 23, wherein the time occasion is determined according to one or more implicit or explicit international mobile subscriber identity values.

25. The method of claim 23, wherein the time occasion is fixed in relation to a system frame number according to a set periodicity.

26. The method of claim 23, wherein the time occasion is determined according to a single fixed relation with a set repetition period.

27. The method of claim 23, wherein the time occasion is tied to the timing of a system information block message.

28. The method of claim 15, wherein the message is identified by at least one of paging radio network temporary identifier, an implicitly or explicitly defined cell radio network temporary identifier, or a combination of at least one of paging radio network temporary identifier and an implicitly or explicitly defined cell radio network temporary identifier.

29. An apparatus, comprising:
at least one processor; and
at least one memory including computer program instructions,
wherein the at least one memory and the computer program instructions are configured to, with the at least one processor, cause the apparatus at least to
listen, at a user equipment, for a proprietary information message, wherein the proprietary message is configured to be un-interpreted by non-configured user equipment, wherein the listening is configured to follow a predefined timing; and
interpret the proprietary information according to a predetermined configuration when the message is received by the user equipment.

30. An apparatus, comprising:
at least one processor; and
at least one memory including computer program instructions,
wherein the at least one memory and the computer program instructions are configured to, with the at least one processor, cause the apparatus at least to
prepare a proprietary information message, wherein the proprietary message is configured to be un-interpreted by non-configured user equipment,
transmit the proprietary information to a user equipment according to a predefined timing, wherein the user equipment is configured to interpret the proprietary information according to a predetermined configuration when the message is received by the user equipment.
